(19) United States
(12) Patent Application Publication
(10) Pub. No.: US 2004/0032381 A1
(43) Pub. Date: Feb. 19, 2004

(54) Circuit and system for driving an organic thin-film EL element and the method thereof

(75) Inventors: Chau-Nan Chung, Hsinchu (TW); Chun-Yu Liao, Taichung City (TW)

Correspondence Address: CHARLES C.H. WU, 7700 IRVINE CENTER DRIVE, SUITE 710, IRVINE, CA, 92618-3043, US

(73) Assignee: Chien-Jung Yuan

(21) Appl. No.: 10/637,378

(22) Filed: Aug. 7, 2003

(30) Foreign Application Priority Data
Aug. 13, 2002 (TW) 091118235

(51) Int. Cl. G09G 3/30

(52) U.S. Cl. 345/76

(57) ABSTRACT

The driving circuit and system of the present invention for driving an organic thin-film EL element to luminesce can speed up the overall display speed by pre-charging the organic thin-film EL element. Since the present invention improves the non-linear distortion in the prior art during signal switching, a more precise value can be obtained on calculating the rang for gray-level display. The present invention can correctly input a data signal with a pulse width proportional to the gray-level to be displayed on the organic thin-film EL element.

### BACKGROUND OF THE INVENTION

(A) Field of the Invention

The present invention relates to a driving circuit and system for an organic thin-film electro luminescent (EL) element to emit light and the driving method for the same, and more particularly, to a driving circuit and system for an organic thin-film EL element with a constant driving current to emit light and the driving method for the same.

(B) Description of the Related Art

The light-emitting luminance of the organic thin-film EL elements varies when the driving current flowing into the element varies. To control the uniformity of luminance of the organic thin-film EL element, the driving current flowing into the element must be controlled and maintained at a specified constant current level.

FIG. 1 shows a driving circuit according to the prior art. In FIG. 1, a constant current supply 13 intends to change the driving current, which is supplied from a power supply 11 to a light-emitting element 12. It should be noted that the light-emitting element 12 emits light when a switch 14 is opened as indicated by the solid line, and ceases to emit light when the switch 14 is shorted as indicated by the dotted line.

FIG. 2 shows another driving circuit according to the prior art. In this configuration, a high resistance 15, which is inserted in series between a light-emitting element 12 and a power supply 11, intends to control the driving current flowing through the light-emitting element 12 to be a constant. It should be noted that the light-emitting element 12 emits light when a switch 16 is located at a position indicated by the solid line, and ceases to emit light when the switch 16 is changed to another position indicated by the dotted line.

FIG. 3 shows an equivalent circuit consisting of a diode 32 and a parasitic capacitor 31 in parallel for the organic thin-film EL element. The parasitic capacitor 31 within the equivalent circuit always causes a response problem, especially in a matrix of organic thin-film EL elements. The organic thin-film EL elements cannot emit light normally unless a voltage difference between both ends exceeds a specified forward voltage Vf. The forward voltage Vf of an LED is as low as +1.5 V to +2 V and also relatively stable. On the other hand, the forward voltage of the organic thin-film EL is as high as +5 V to 12 V, and also greatly varies in accordance with luminance, temperature and time passage. Besides, the parasitic capacitance effect is more severe in an organic thin-film EL element than in an LED due to a higher forward voltage Vf The forward voltage Vf has to rise above the specified voltage value for luminance and the rise time is dependent on the total charging time of all the parasitic capacitors parasitizing in the organic thin-film EL elements. Normally, the power supply is required to boost to a Vcc voltage potential higher than the forward voltage Vf in order to drive the organic thin-film EL element to emit light.

FIG. 4 shows a driving system 40 for driving luminous elements according to the prior art. In FIG. 4, the driving system 40 is constructed with a matrix arrangement of the number of N×M (only 6×5 organic thin-film EL elements appear in FIG. 4), in which the cathode-scanning unit consists of N number of cathode scanning lines. The cathodes of organic thin-film EL elements are connected to the switches 7₁ to 7ₙ through the cathode scanning line X₁ to Xₙ for selecting a power potential V_{B} or a ground potential. The anode data-driving unit consists of M number of anode data-driving lines. The anode data-driving lines Y₁ to Yₘ are individually connected to the switches 11₁ to 11ₘ for connecting to constant current sources 10₁ to 10ₘ or the ground potential. The prior art driving system 40 causes the luminous elements at an arbitrary intersection to emit light by selecting and scanning one of the anode lines and the cathode lines sequentially at a fixed time interval.

According to the prior art, the driving system 40 always causes problems once used in driving a matrix of organic thin-film EL elements for luminance. The main problem is that the scanning speed will be slowed down due to the parasitic capacitors described above. When the organic thin-film EL is used as a luminous element, this problem becomes more severe since the organic thin-film EL has a large capacitor to generate a surface emission. The above problem is more severe when the number of the luminous elements increases since the organic thin-film EL will accumulate all the parasitic capacitors. Furthermore, the parasitic capacitors of all luminous elements connected to the anode lines have to be charged, and the current sources for driving the luminous elements connected to each anode line must be designed large enough to satisfy the appropriated response time. This requirement for generating large current sources is detrimental from the aspect of miniaturization of the circuit.

FIG. 5 is a timing chart of the driving system 40 shown in FIG. 4. FIG. 5 shows the parasitic capacitor problem in the switching operations of the switches 7ᵢ₋₁, 7ᵢ, 7ᵢ₊₁, and 11ⱼ. The potential of Yⱼ data electrodes can not increase immediately due to the parasitic capacitance in the reverse bias direction of at least (n−1) pixels. A delay time t_{d} occurs until a forward bias is applied to the pixel D(i, j) for light emission. In addition, the current source 10ⱼ will limit the increasing rate of the potential of the Yⱼ data electrodes and results in a larger delay time t_{d}.

FIG. 6 shows a current response when an input voltage pulse is applied to an organic thin-film EL element. In FIG. 6, a curve 61 represents the organic thin-film EL element current response, and a curve 62 represents the voltage pulse. It is clear that the rise time is longer than the fall time. This indicates that the time for capacitance discharge is shorter than the time for capacitance charge in the organic thin-film EL element. The advantage of a shorter capacitance discharge time can be used to develop a fast response driving circuit for an organic thin-film EL display. In the prior art driving system 40 shown in FIG. 4, a constant current source 10ⱼ is connected to a set of parallel organic thin-film EL elements, D(1, j) through D(n, j), following to the ground potential in D(i,j) and to the power potential in the rest of D(1 to i−1, j) and D(i+1 to n, j). Normally, the constant current source is used for generating a magnitude of current to light up an organic thin-film EL element. It should be noted that the parasitic capacitors in parallel could enhance the parasitic capacitance effect compared with that of a single organic thin-film EL element. The current source limits the current and worsens the response to emit light of the scanned organic thin-film EL element D(i, j) due to the above parasitic capacitance effect when a power potential is applied. U.S. Pat. No. 6,201,520 and U.S. Pat. No. 5,844,368 proposed several methods to improve the response to emit light in prior art organic thin-film EL display driving system. However, the above methods do not really resolve the existent problems.

Moreover, for the gray-level display, the pulse width of an input gray-level signal is normally proportional to the brightness of the gray-level. However, the quality of the overall gray-level is difficult to evaluate due to the above-mentioned parasitic capacitance effect. The prior art method solves this problem by decreasing the number of the overall gray-level, but results in a deterioration of the image display quality.

### SUMMARY OF THE INVENTION

The objective of the present invention is to resolve the problems and disadvantages of the related art. The objective of the present invention is to provide a driving circuit and system for driving an organic thin-film EL element to emit light and the driving method for the same. The present invention can speed up the overall display speed by pre-charging the organic thin-film EL element. Since the present invention improves the non-linear distortion in the prior art during signal switching, a more precise value can be obtained while displaying the gray-level.

According to the first embodiment of the present invention, a driving circuit for driving the organic thin-film EL element comprises an anode-scanning switch, an organic thin-film EL element, a constant current source, a pre-charging switch and a cathode data-driving switch. The anode-scanning switch is electrically connected to the power potential while the organic thin-film EL element is scanned and electrically connected to the ground potential otherwise. The organic thin-film EL element is electrically connected to the anode-scanning switch, and the pre-charging switch is electrically connected in parallel to the constant current source. One end of the cathode data-driving switch is electrically connected to the organic thin-film EL element, and the other end is electrically connected to the constant current source while the organic thin-film EL element is selected and electrically connected to the power potential otherwise.

According to the second embodiment of the present invention, a driving system for driving the organic thin-film EL element comprises m rows of anode-scanning switch, n columns of constant current sources, n columns of pre-charging switches, an m×n matrix of organic thin-film EL elements, n columns of cathode data-driving switch and a signal control unit. The anode-scanning switch is electrically connected to the power potential while an organic thin-film EL element electrically connected to the anode-scanning switch is scanned and electrically connected to the ground potential otherwise. The pre-charging switch is electrically connected in parallel to the constant current source. Organic thin-film EL elements in the same row are electrically connected to a corresponding anode-scanning switch, and organic thin-film EL elements in the same column are electrically connected to a corresponding cathode data-driving switch. One end of the cathode data-driving switch is electrically connected to a corresponding organic thin-film EL element, and the other end is electrically connected to the constant current source while the corresponding organic thin-film EL element is selected and electrically connected to the power potential otherwise. The signal control unit is used for generating the control signal for switching the anode-scanning switches, the cathode data-driving switches, and the pre-charging switches.

The present invention method for driving an organic thin-film EL element comprises the Steps (a) to (d). In Step (a), a scanning signal is inputted sequentially. In Step (b), the organic thin-film EL element is pre-charged. In Step (c), a time range is determined for calculating gray-level value, which starts at the ending of the pre-charging procedure and ends at the ending of the scanning signal. In Step (d), a data signal with a pulse width is inputted, wherein the pulse width is proportional to the gray-level to be displayed on the organic thin-film EL element.

### BRIEF DESCRIPTION OF THE DRAWINGS

Other objectives and advantages of the present invention will become apparent upon reading the following description and upon reference to the accompanying drawings in which:

FIG. 1 shows a driving circuit for an organic thin-film EL element according to the prior art;

FIG. 2 shows another driving circuit for an organic thin-film EL element according to the prior art;

FIG. 3 shows an equivalent circuit consisted of a diode and a parasitic capacitor in parallel for the organic thin-film EL element;

FIG. 4 shows a driving system for a luminous device according to the prior art;

FIG. 5 is the timing chart of the driving system shown in FIG. 4;

FIG. 6 shows the current responses of the organic thin-film EL element when an input voltage pulse is applied;

FIG. 7 shows a driving circuit for driving an organic thin-film EL element according to the first embodiment of the present invention;

FIG. 8 shows an equivalent circuit for the first embodiment of the present invention;

FIG. 9 to FIG. 13 illustrate schematic diagrams showing a driving system consisting of the driving circuit shown in FIG. 7;

FIG. 14 shows the timing chart of the driving system shown in FIG. 9 to FIG. 13; and

FIG. 15 shows an equivalent driving system of the driving system shown in FIG. 9.

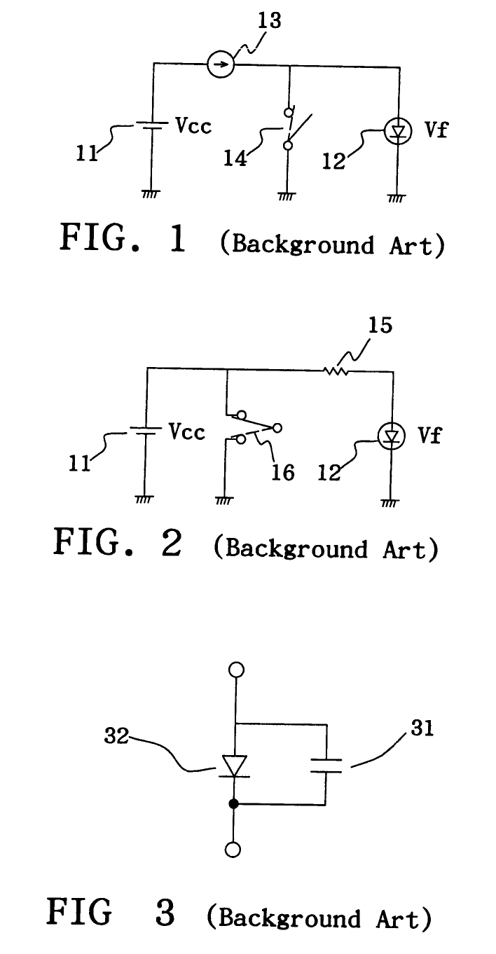

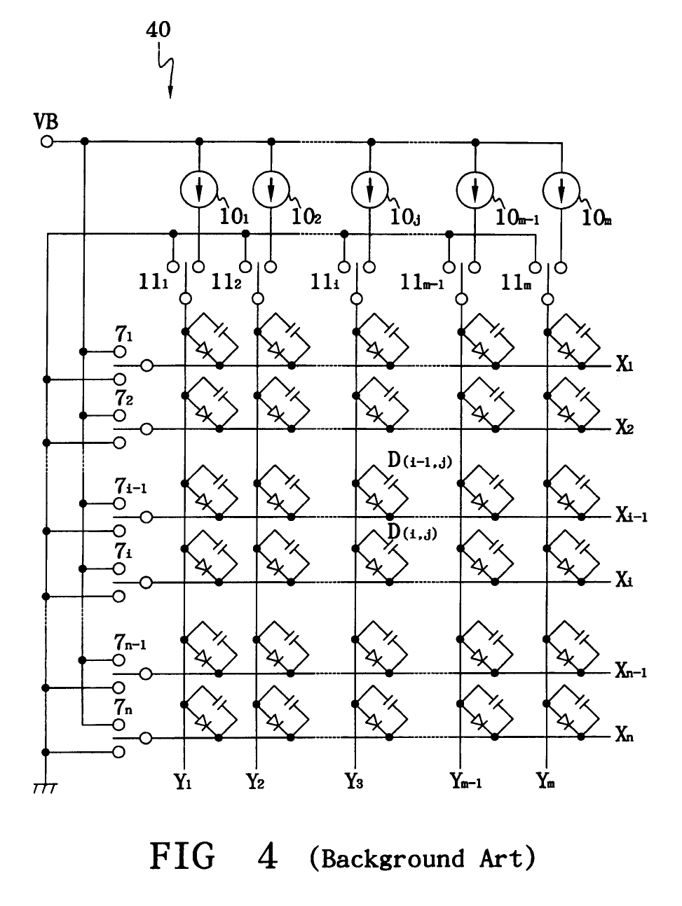

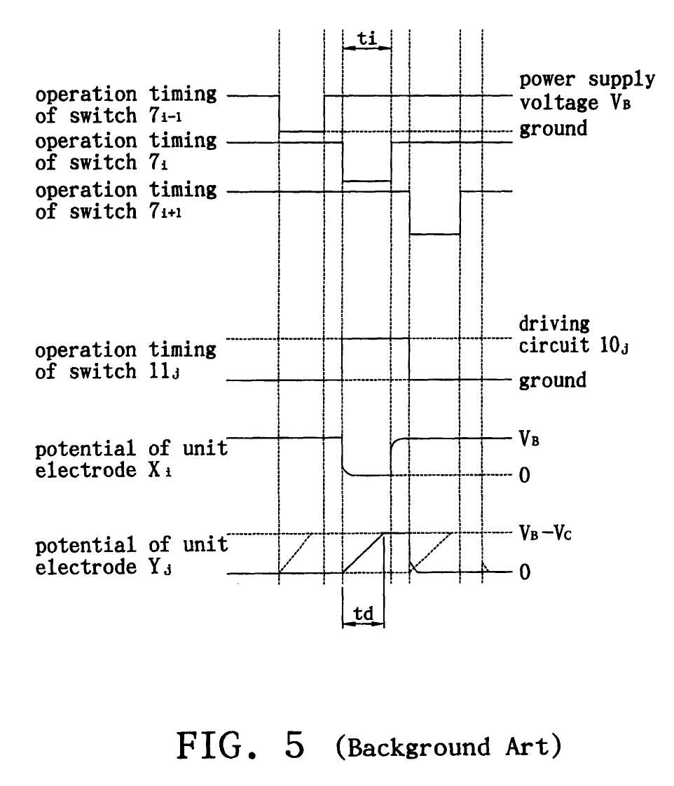

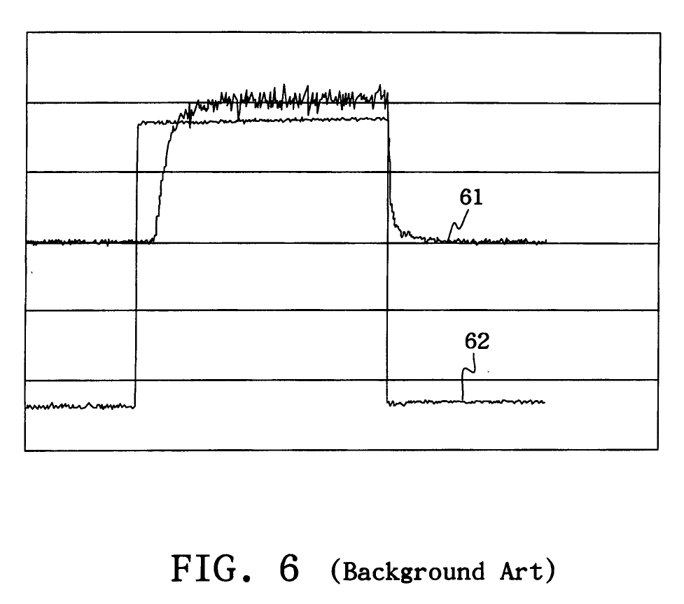

### DETAILED DESCRIPTION OF THE INVENTION

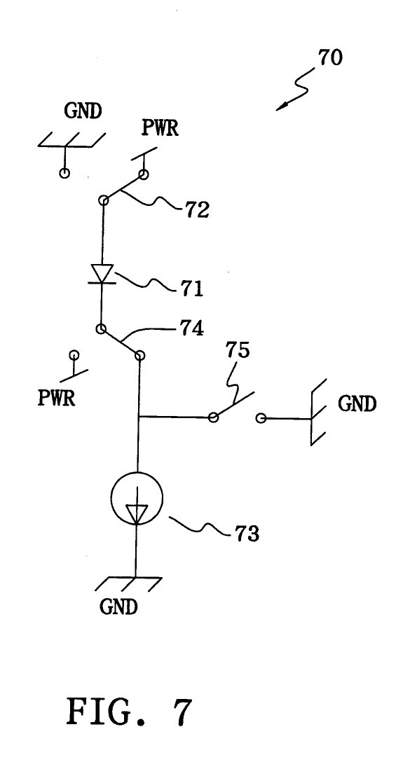

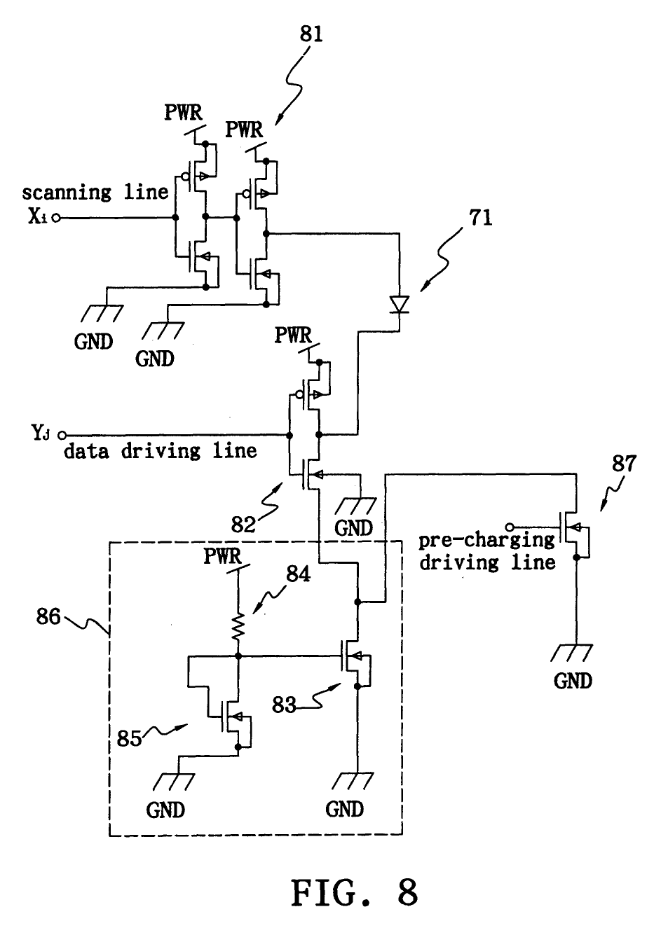

FIG. 7 illustrates a driving circuit 70 for driving an organic thin-film EL element according to the first embodiment of the present invention. The organic thin-film EL element 71 is electrically connected between an anode-scanning switch 72 and a cathode data-driving switch 74. The driving circuit 70 further comprises a constant current source 73 that is electrically connected in parallel to a pre-charging switch 75. The anode-scanning switch 72 and the cathode data-driving switch 74 are used to control the luminance of the organic thin-film EL element 71. The anode-scanning switch 72 is electrically connected to a power potential (PWR) while the organic thin-film EL element 71 is scanned and electrically connected to the ground potential (GND) otherwise. Relatively, the cathode data-driving switch 74 is electrically connected to the constant current source 73 while the organic thin-film EL element 71 is selected and electrically connected to the power potential otherwise. One end of the constant current source 73 is electrically connected to the ground potential and the other end is electrically connected to the cathode data-driving switch 74. One end of the pre-charging switch 75 is electrically connected to the constant current source 73 and the other end is electrically connected to the ground potential. According to the present invention, one technical advantage of the driving circuit 70 is that the organic thin-film EL element 71 can be rapidly charged and discharged, and this advantage will be more significant for many organic thin-film EL elements 71 connected in parallel. Generally speaking, the organic thin-film EL element 71 has to be charged before applying a current to emit light. This property influences the output speed and quality of the image.

FIG. 8 illustrates an equivalent circuit for the first embodiment of the present invention. The anode-scanning switch 72 and the cathode data-driving switch 74 are implemented by CMOS inverters 81 and 82, and the stage of the CMOS inverter is dependent on the desired driving capability. The constant current source 73 (shown in FIG. 7) for driving the organic thin-film EL element is implemented by a current mirror circuit 86, as shown in FIG. 8. The current mirror circuit 86 comprises a constant current N-channel MOSFET 83, a reference N-channel MOSFET 85 and a reference resistor 84. The reference N-channel MOSFET 85 and the reference resistor 84 are used to generate the specified constant driving current, and control the gate voltage potential of the constant current N-channel MOSFET 83. The resistance of the reference resistor 84 can change the driving current flowing into the organic thin-film EL element 71. Moreover, the pre-charging switch 75 (shown in FIG. 7) can be implemented by a N-channel MOSFET switch 87.

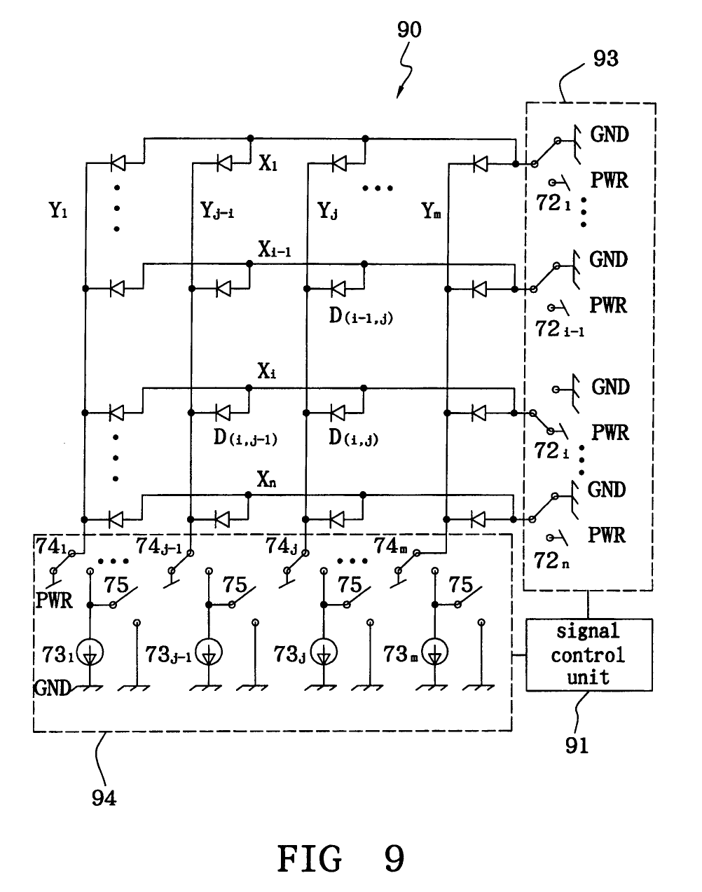

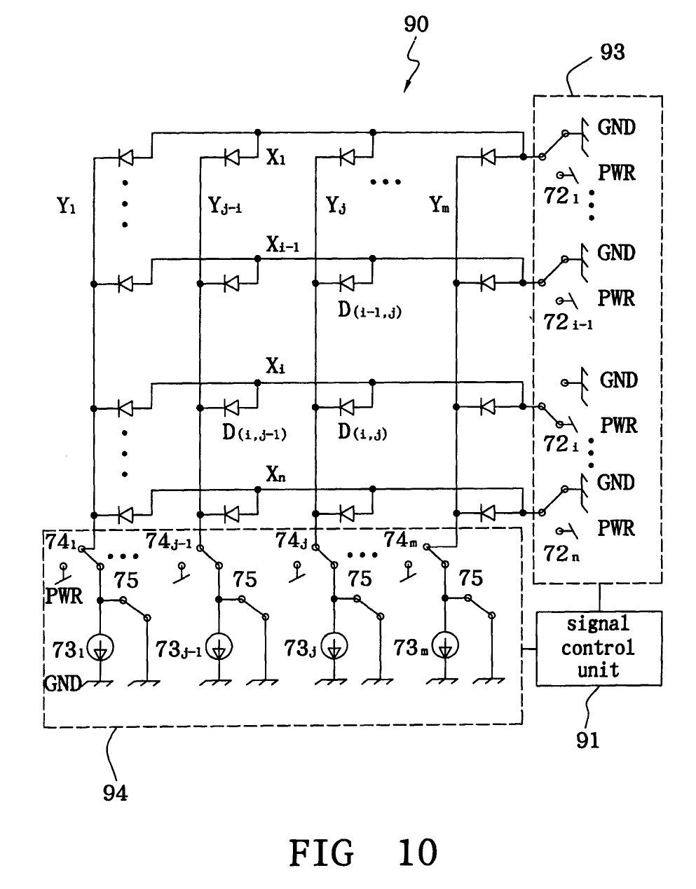

FIG. 9 to FIG. 13 illustrate a driving system 90 consisting of the driving circuit 70 for the organic thin-film EL element. The driving system 90 comprises an anode-scanning unit 93 and a cathode data-driving unit 94. The anode-scanning unit 93 comprises anode-scanning switches 72₁ to 72ₙ. The cathode data-driving unit 94 comprises cathode data-driving switches 74₁ to 74ₘ, constant current sources 73₁ to 73ₘ and pre-charging switches 75. Anode-scanning lines X₁ to Xₙ are electrically connected to the anode-scanning switches 72₁ to 72ₙ, respectively. A corresponding anode-scanning switch is electrically connected to the power potential while the corresponding anode-scanning line is selected and electrically connected to the ground potential otherwise. Data-driving lines Y₁ to Yₙ are electrically connected to the cathode data-driving switches 74₁ to 74ₘ, respectively, and subsequently connected to the constant current sources 73₁ to 73ₘ. The m numbers of pre-charging switches 75 are electrically connected in parallel to the constant current sources 73₁ to 73ₘ for providing a rapid charging path. If data-driving lines Y₁ to Yₘ are set to be the power potential, the organic thin-film EL element will not luminesce; on the contrary, if the data-driving lines are electrically connected to the constant current source 75, the organic thin-film EL element will luminesce. As shown in FIG. 9, the anode-scanning switches 72₁ to 72ₘ, the cathode data-driving switches 74₁ to 74ₘ, and the pre-charging switch 75 are controlled by an output control signal from a signal control unit 91.

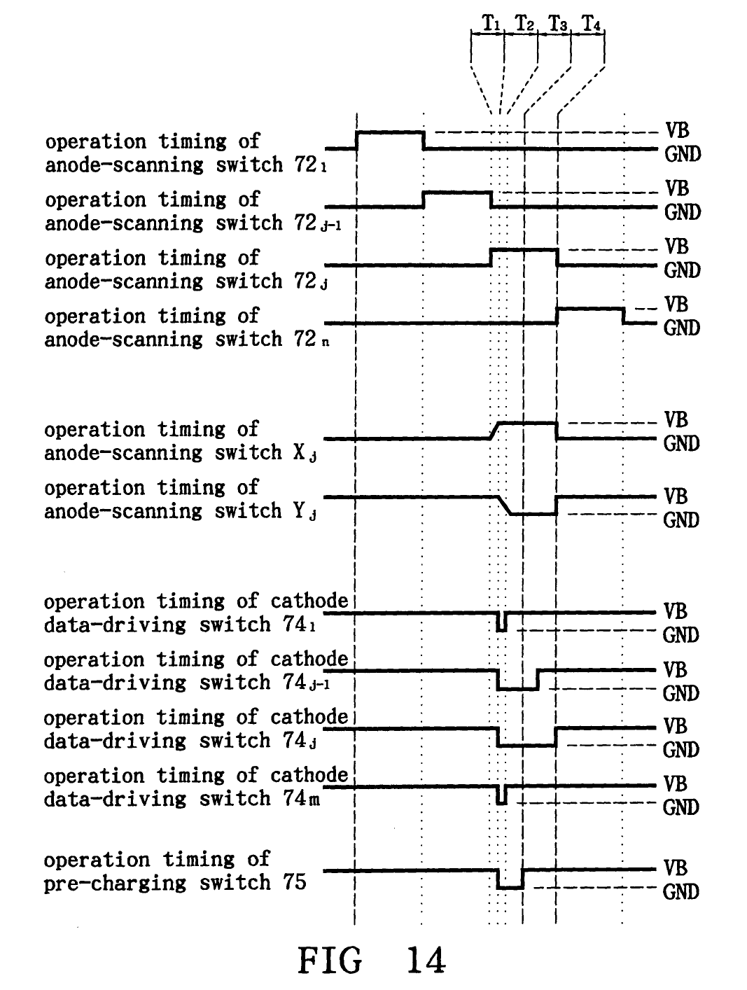

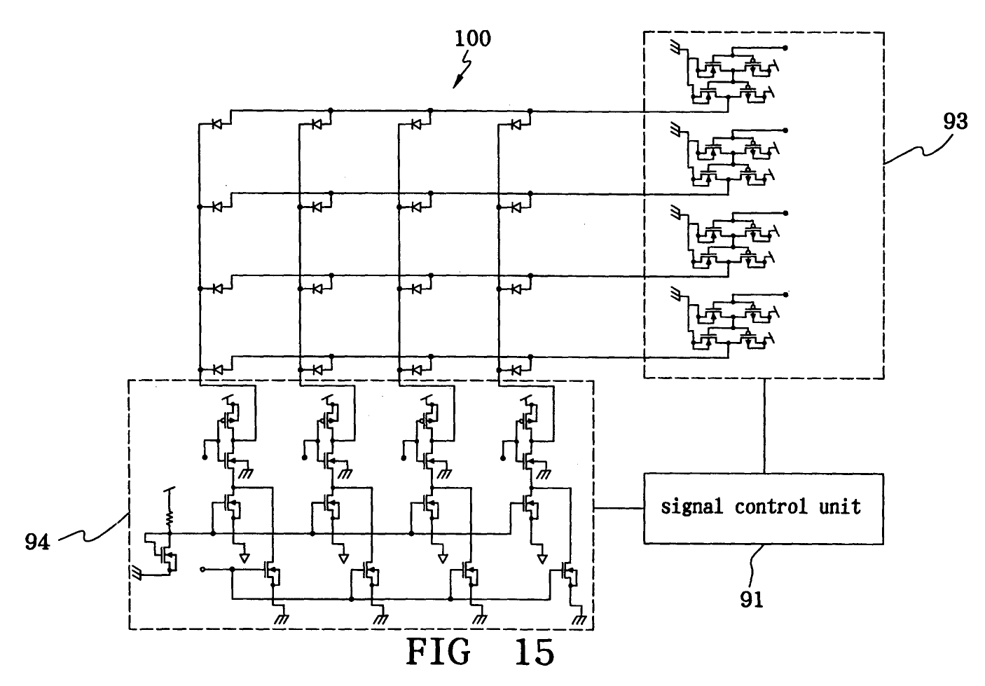

FIG. 14 shows the timing chart of the driving system 90 according to the present invention. FIG. 14 shows the operations of the anode-scanning switches 72₁ to 72ₘ, the cathode data-driving switches 74₁ to 74ₘ and the pre-charging switch 75, and the potential variation of the anode-scanning line Xᵢ electrically connected to the anode-scanning switch 72ᵢ and that of the driving line Yⱼ electrically connected to the cathode data-driving switch 74ⱼ. Generally speaking, the anode-scanning switches 72₁ to 72ₙ sequentially input a scanning signal to the matrix consisting of the luminous elements.

Referring to FIG. 9, the anode-scanning switch 72ᵢ is activated in the time period T₁. Because of the parasitic resistance and capacitance effect in the driving system 90, the potential variation of the anode-scanning line Xᵢ connected to the anode-scanning switch 72ᵢ will be delayed.

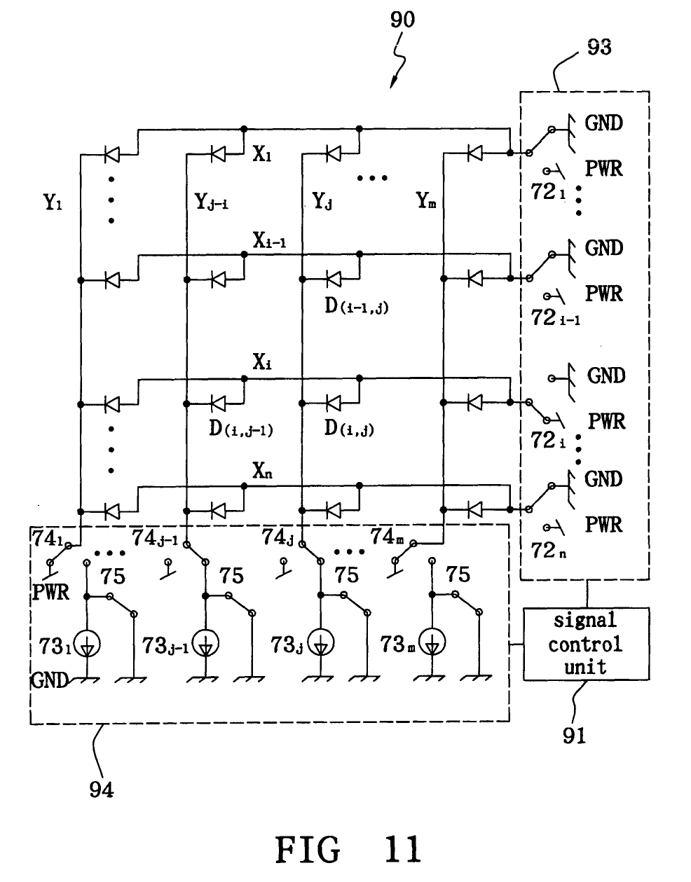

Referring to FIG. 10, the cathode data-driving switches 74₁ to 74ₘ, and the pre-charging switch 75 are all activated in the time period T₂ for pre-charging all the luminous elements electrically connected to the anode-scanning line Xᵢ. Because the pre-charging switch 75 is activated at this time, the charging time can be reduced.

Referring to FIG. 11, the cathode data-driving switches 74₁ and 74ₘ, electrically connected to the luminous elements not to luminesce, are electrically connected to the power potential in the time period T₃. The pre-charging switch 75 can be kept at the connection state according to the setting of the program parameters.

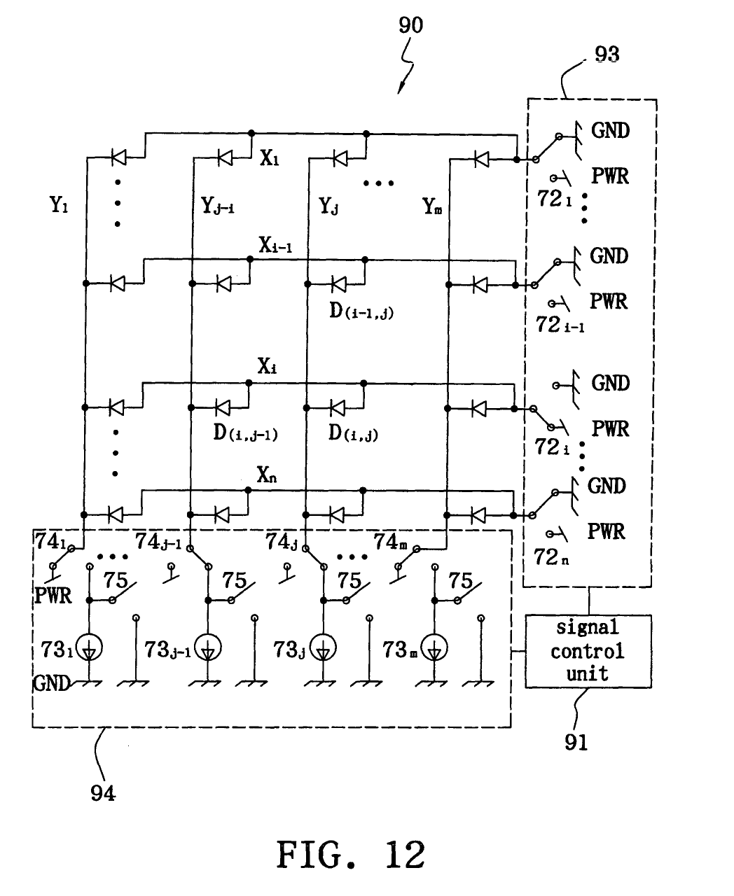

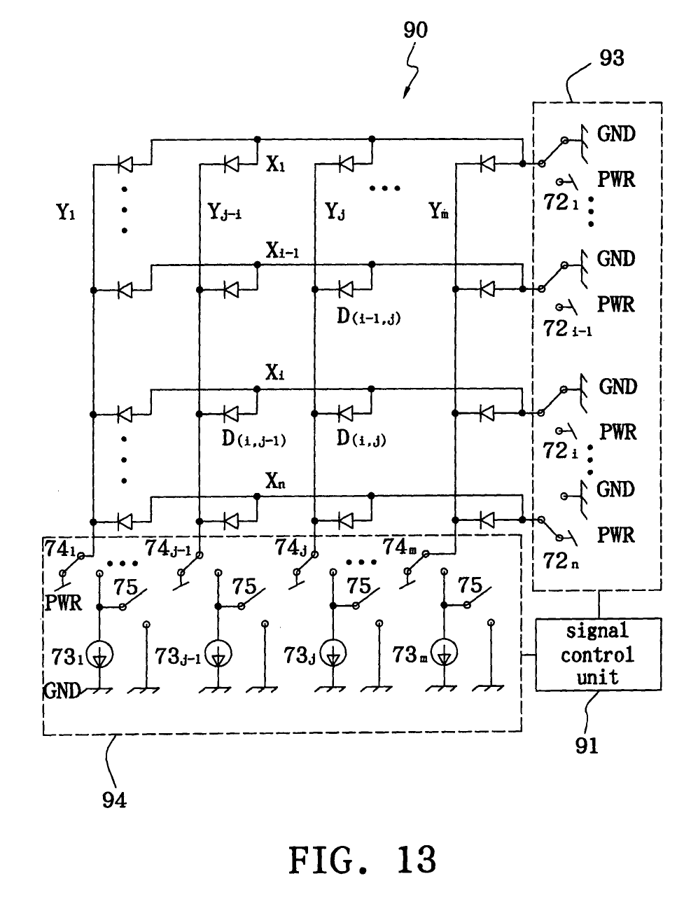

Referring to FIG. 12, a time range (the time period T₄) is determined for calculating gray-level value, which starts at the ending of the pre-charging procedure (the pre-charging switch 75 becomes open) and ends at the ending of the scanning signal (the scanning signal switch 72ᵢ becomes open). For example, if there are 256 gray-levels and 64 nano-seconds for the time period T₄, the cathode data-driving switch should be kept at the active state for 0.25 nano-seconds for displaying one unit of gray-level. In other words, a data signal with a pulse width is inputted in the time period T₄, wherein the pulse width is proportional to the gray-level to be displayed on the luminous elements D(i, j−1) and D(i, j). Since the pre-charging switch 75 is opened and the constant current source is at the connection state, the luminous elements D(i, j−1) and D(i, j) will luminesce according to the designed gray-level. When the luminous elements D(i, j−1) and D(i, j) have displayed, the corresponding cathode data-driving switches 74ⱼ₋₁ and 74ⱼ are then connected to the power potential, as shown in FIG. 13.

FIG. 15 illustrates an equivalent driving system 100 for the driving system 90 shown in FIG. 9. Each of the anode-scanning switches 72₁ to 72ₙ in the anode-scanning unit 93, and each of the cathode data-driving switches 74₁ to 74ₘ in the cathode data-driving unit 94 are implemented by CMOS inverters. Each of the constant current sources 73₁ to 73ₘ are implemented by the current mirror circuits 86, and the m piece of pre-charging switches 75 are implemented by the N-channel MOSFET switches 87. The signal control unit 91 is used to generate the control signals for each of the anode-scanning switches 72₁ to 72ₘ, each of the cathode data-driving switches 74₁ to 74ₘ, and the pre-charging switch 75 according to the timing shown in FIG. 14.

The above-described embodiments of the present invention are intended to be illustrative only. Numerous alternative embodiments may be devised by those skilled in the art without departing from the scope of the following claims.

What is claimed is:

1. A circuit for driving an organic thin-film electro luminescent (EL) element, comprising:
an anode-scanning switch electrically connected to a power potential while the organic thin-film EL element is scanned and electrically connected to a ground potential otherwise;
an organic thin-film EL element electrically connected to the anode-scanning switch;
a constant current source;
a pre-charging switch electrically connected to the constant current source in parallel; and
a cathode data-driving switch, one end of the cathode data-driving switch electrically connected to the organic thin-film EL element, the other end of the cathode data-driving switch electrically connected to the constant current source while the organic thin-film EL element is selected and electrically connected to the power potential otherwise.

2. The circuit for driving an organic thin-film EL element of claim 1, wherein the anode-scanning switch comprises at least one CMOS inverter.

3. The circuit for driving an organic thin-film EL element of claim 1, wherein the cathode data-driving switch comprises at least one CMOS inverter.

4. The circuit for driving an organic thin-film EL element of claim 1, wherein the constant current source comprises a current mirror circuit.

5. The circuit for driving an organic thin-film EL element of claim 4, wherein the current mirror circuit comprises:
a constant current N-channel MOSFET;
a reference resistor, one end of the reference resistor electrically connected to the power potential and the other end electrically connected to a gate of the constant current N-channel MOSFET; and
a reference N-channel MOSFET, a source of the reference N-channel MOSFET electrically connected to the ground potential, and a gate and drain of the reference N-channel MOSFET electrically connected to the gate of the constant current N-channel MOSFET.

6. The circuit for driving an organic thin-film EL element of claim 1, wherein the pre-charging switch comprises an N-channel MOSFET switch.

7. A system for driving organic thin-film EL elements, comprising:
n rows of anode-scanning switches, wherein an anode-scanning switch is electrically connected to a power potential while an organic thin-film EL element electrically connected to the anode-scanning switch is being scanned, and electrically connected to a ground potential otherwise, wherein n is an integer;
m columns of constant current sources, wherein m is an integer;
m columns of pre-charging switches electrically connected to the constant current source in parallel;
m columns of cathode data-driving switches, wherein a cathode data-driving switch is electrically connected to the constant current source while an organic thin-film EL element electrically connected to the cathode data-driving switch is being selected, and electrically connected to a power potential otherwise;
an m x n matrix of organic thin-film EL elements, wherein organic thin-film EL elements in the same row are electrically connected to a corresponding anode-scanning switch, and organic thin-film EL elements in the same column are electrically connected to a corresponding cathode data-driving switch; and
a signal control unit for generating control signals to switch the anode-scanning switches, the cathode data-driving switches and the pre-charging switches.

8. The system for driving organic thin-film EL elements of claim 7, wherein the anode-scanning switch comprises at least one CMOS inverter.

9. The system for driving organic thin-film EL elements of claim 7, wherein the cathode data-driving switch comprises at least one CMOS inverter.

10. The system for driving organic thin-film EL elements of claim 7, wherein the constant current source comprises a current mirror circuit.

11. The system for driving organic thin-film EL elements of claim 10, wherein the current mirror circuit comprises:
a constant current N-channel MOSFET;
a reference resistor, one end of the reference resistor electrically connected to the power potential and the other end electrically connected to a gate of the constant current N-channel MOSFET; and
a reference N-channel MOSFET, a source of the reference N-channel MOSFET electrically connected to the ground potential, and a gate and drain of the reference N-channel MOSFET electrically connected to the gate of the constant current N-channel MOSFET.

12. The system for driving an organic thin-film EL elements of claim 7, wherein the pre-charging switch comprises an N-channel MOSFET switch and is activated as the cathode data-driving switch is activated.

13. A method for driving an organic thin-film EL element, comprising the steps of:
sequentially inputting a scanning signal;
pre-charging the organic thin-film EL element;
determining a time range for calculating gray-level value which starts at the ending of the pre-charging procedure and ends at the ending of the scanning signal; and
inputting a data signal with a pulse width proportional to the gray-level value to be displayed on the organic thin-film EL element.

14. The method for driving an organic thin-film EL element of claim 13, wherein the pre-charging time is controlled by parameters of a program.
